(19) United States
(12) Patent Application Publication
(10) Pub. No.: US 2026/0269328 A1
(43) Pub. Date: Sep. 10, 2026

(54) METAL-AIR BATTERY CELL, METAL-AIR BATTERY, AND OPERATION METHOD OF THE METAL-AIR BATTERY

(71) Applicant: Samsung Electronics Co., Ltd., Suwon-si (KR)

(72) Inventors: Mokwon Kim, Suwon-si (KR); Taeyoung Kim, Suwon-si (KR); Jungock Park, Suwon-si (KR); Jaeho Shin, Suwon-si (KR); Heungchan Lee, Suwon-si (KR)

(21) Appl. No.: 19/467,993

(22) Filed: Feb. 3, 2026

(30) Foreign Application Priority Data
Feb. 25, 2025 (KR) 10-2025-0024588

(51) Int. Cl. H01M 10/42; H01M 10/48; H01M 12/08; H01M 50/138

(52) U.S. Cl. CPC H01M 10/4214; H01M 10/425; H01M 10/48; H01M 12/08; H01M 50/1385

(57) ABSTRACT

A metal-air battery cell capable of generating constant output power. The metal-air battery cell may include a metal anode including an end and a lateral surface extending from the end, a cathode surrounding and spaced apart from the lateral surface of the metal anode, an electrolyte between the metal anode and the cathode and in contact with the end of the metal anode and a portion of the lateral surface of the metal anode, and an anode injector configured to move the metal anode to increase an area of the lateral surface of the metal anode contacting the electrolyte.

### CROSS-REFERENCE TO RELATED APPLICATION

This application claims priority to and the benefit of Korean Patent Application No. 10-2025-0024588, filed on Feb. 25, 2025, in the Korean Intellectual Property Office, and all the benefits accruing therefrom under 35 U.S.C. § 119, the content of which in its entirety is herein incorporated by reference.

### BACKGROUND

### 1. Field

The disclosure relates to a metal-air battery cell, a metal-air battery, and an operation method of the metal-air battery.

### 2. Description of the Related Art

Metal-air batteries may each include a plurality of metal-air battery cells, and each of the metal-air battery cells may include an anode capable of absorbing/releasing ions and a cathode configured to use oxygen in air as an active material. At the cathode, reduction/oxidation of oxygen introduced from outside of the metal-air battery occurs, at the anode, oxidation/reduction of a metal occurs, and chemical energy generated is extracted as electrical energy. For example, metal-air batteries absorb oxygen during discharge and release oxygen during charge. Metal-air batteries use oxygen present in the air, and the energy density of metal-air batteries may be significantly improved. For example, the energy density of metal-air batteries may be greater than the energy density of lithium-ion batteries, for example, by several orders of magnitude.

Metal-air batteries are highly stable and have a low risk of ignition at abnormally high temperatures, operate only through absorption/release of oxygen, and are unlikely to cause environmental pollution

### SUMMARY

Provided are a metal-air battery cell and a metal-air battery that are capable of maintaining constant output power, and an operation method of the metal-air battery.

Additional aspects will be set forth in part in the description which follows and, in part, will be apparent from the description, or may be learned by practice of the presented embodiments of the disclosure.

According to an aspect of the disclosure, a metal-air battery cell includes a metal anode including an end and a lateral surface extending from the end, a cathode surrounding and spaced apart from a lateral surface of the metal anode, an electrolyte between the metal anode and the cathode and in contact with the end of the metal anode and a portion of the lateral surface of the metal anode, and an anode injector configured to move the metal anode to increase an area of the lateral surface of the metal anode contacting the electrolyte.

The metal anode may include a reaction region, wherein a lateral surface of the reaction region is surrounded by the cathode and in contact with the electrolyte, and a reserve region extending from the reaction region, wherein a lateral surface of the reserve region is not in contact with the electrolyte.

The anode injector may be configured to move at least a portion of the reserve region into the electrolyte.

As the at least a portion of the reserve region is moved into the electrolyte by the anode injector, a length of the reserve region of the metal anode may decrease.

The anode injector may be configured to continuously move the at least a portion of the reserve region into the electrolyte.

The anode injector may be configured to discontinuously move the at least a portion of the reserve region into the electrolyte.

The metal-air battery cell may further include a detector configured to detect information about a state of the metal anode, and a controller configured to control operation of the anode injector, based on the information detected by the detector.

The metal-air battery cell may further include an anode rotator configured to rotate the metal anode in the electrolyte.

The anode rotator may be further configured to continuously rotate the metal anode.

The anode rotator may be further configured to discontinuously rotate the metal anode.

The metal anode may may have a columnar shape, and the cathode may may have a cylindrical shape.

According to an aspect of the disclosure, a metal-air battery includes a plurality of metal-air battery cells, wherein each of the plurality of metal-air battery cells includes a metal anode including an end and a lateral surface extending from the end, a cathode surrounding and spaced apart from the lateral surface of the metal anode, an electrolyte between the metal anode and the cathode and in contact with the end of the metal anode and a portion of the lateral surface of the metal anode, and an anode injector configured to move the metal anode to increase an area of the lateral surface of the metal anode contacting the electrolyte.

The metal anode may include a reaction region, wherein a lateral surface of the reaction region is surrounded by the cathode and in contact with the electrolyte, and a reserve region extending from the reaction region, wherein a lateral surface of the reserve region is not in contact with the electrolyte.

The anode injector may be configured to move at least a portion of the reserve region into the electrolyte.

As the at least a portion of the reserve region is moved into the electrolyte by the anode injector, a length of the reserve region of the metal anode may decrease.

The anode injector may be configured to continuously move the at least a portion of the reserve region into the electrolyte.

The metal-air battery may further include a detector configured to detect information about a state of the metal anode of each of the plurality of metal-air battery cells, and a controller configured to individually control operation of the anode injector of each of the plurality of metal-air battery cells, based on the information detected by the detector.

Each of the plurality of metal-air battery cells may further include an anode rotator configured to rotate the metal anode in the electrolyte.

According to an aspect of the disclosure, there is provided an operation method of a metal-air battery including a metal-air battery cell. The metal-air battery cell includes a metal anode including an end and a lateral surface extending from the end, a cathode surrounding and spaced apart from a lateral surface of the metal anode, the cathode including a reaction region facing the cathode and in contact with the electrolyte, and an electrolyte between the metal anode and the cathode and in contact with the end of the metal anode and a portion of the lateral surface of the metal anode. The operation method includes consuming the end of the metal anode, and moving the metal anode to maintain an area of a lateral surface of the reaction region of the metal anode within a predetermined range.

According to an aspect of the disclosure, there is provided an operation method of a metal-air battery including a metal-air battery cell, the metal-air battery cell including a metal anode including an end and a lateral surface extending from the end, a cathode surrounding and spaced apart from the lateral surface of the metal anode, the cathode including a reaction region facing the cathode and in contact with the electrolyte, an electrolyte between the metal anode and the cathode and in contact with the end of the metal anode and a portion of the lateral surface of the metal anode, an anode injector configured to move the metal anode to increase an area of the lateral surface of the metal anode contacting the electrolyte, a detector configured to detect information about a state of the metal anode, and a controller configured to control operation of the anode injector, based on the information detected by the detector, the operation method including detecting information about a state of the metal anode; and controlling operation of the anode injector, based on the information detected by the detector, to discontinuously move the metal anode to increase the area of the lateral surface of the metal anode contacting the electrolyte.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view schematically illustrating a structure of a metal-air battery cell according to an embodiment;

FIG. 2 is a cross-sectional view illustrating the metal-air battery cell shown in FIG. 1;

FIG. 3 is a view illustrating current density vectors in an electrolyte around a metal anode when a metal-air battery cell according to an embodiment is discharging in a state in which, e.g., while, the metal anode is rotating;

FIG. 4 is a view illustrating a state of a metal anode when discharge of a metal-air battery cell is in progress, e.g., while the metal-air battery cell is discharging;

FIG. 5 is a view schematically illustrating a metal-air battery cell according to an embodiment;

FIG. 6 is a block diagram illustrating operation of a metal-air battery cell according to an embodiment;

FIG. 7 is a view illustrating a metal-air battery according to an embodiment; and

FIG. 8 is a view schematically illustrating an operation method of a metal-air battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Hereinafter, a metal-air battery cell, a metal-air battery, and an operation method of the metal-air battery will be described with reference to the accompanying drawings. In the drawings, the size of each component may be exaggerated for clarity of illustration. The following embodiments are examples, and various changes in form and details may be made therein. It will also be understood that when a layer is referred to as being “above” or “on” another layer or substrate, it may be directly on the other layer or substrate or be above the layer or substrate without making contact with the layer or substrate.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower,” “down,” or “downward” and “upper,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “above” other elements would then be oriented “below” the other elements. The exemplary term “above” can, therefore, encompass both an orientation of above and below.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used, e.g., non-technical, dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

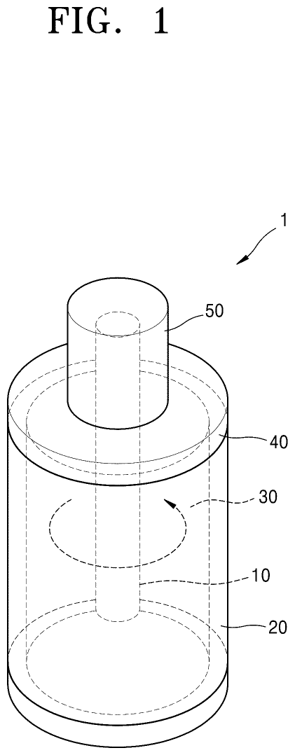

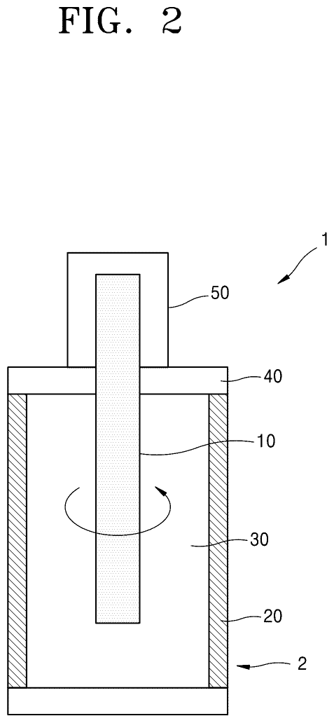

FIG. 1 is a perspective view schematically illustrating a structure of a metal-air battery cell 1 according to an embodiment, and FIG. 2 is a cross-sectional view illustrating the metal-air battery cell 1 shown in FIG. 1.

Referring to FIGS. 1 and 2, the metal-air battery cell 1 may include a metal anode 10, an electrolyte 30, and a cathode 20. The metal anode 10, the electrolyte 30, and the cathode 20 may be disposed inside a housing 2.

The metal anode 10 may extend in a length direction thereof. The metal anode 10 may have a columnar shape. The metal anode 10 may have a cylindrical shape. The metal anode 10 may have a constant diameter along the length of the metal anode.

The metal anode 10 has a function of absorbing/releasing metal ions. The metal anode 10 may include, for example, lithium (Li), sodium (Na), zinc (Zn), potassium (K), calcium (Ca), magnesium (Mg), iron (Fe), aluminum (Al), or an alloy thereof.

The metal anode 10 may include aluminum (Al). A metal-air battery including the metal-air battery cell 1 may be referred to as an aluminum-air battery (AAB). Although not shown in FIGS. 1 and 2, an anode current collector may be disposed in contact with the metal anode 10. The anode current collector may include a conductor such as stainless steel.

The electrolyte 30 may include an aqueous electrolyte capable of providing hydroxide ions (OH⁻) through a reaction with oxygen supplied from the cathode 20. For example, the electrolyte 30 may include an alkaline aqueous solution. For example, the electrolyte 30 may include sodium hydroxide or potassium hydroxide.

An oxygen reduction reaction (ORR) may occur at the cathode 20. The cathode 20 may be referred to as an air electrode. Oxygen (O₂) from the outside, such as from the air, may be supplied to the cathode 20, and hydroxide ions (OH⁻) may be generated as the oxygen (O₂) reacts with water vapor (H₂O) and undergoes reduction. The hydroxide ions (OH⁻) are supplied to the metal anode 10 and may combine with metal ions supplied from the metal anode 10. The cathode 20 may provide an electron transfer pathway for an ORR.

Although not shown in FIGS. 1 and 2, a gas diffusion layer for absorbing oxygen from the atmosphere and supplying the oxygen to the cathode 20 may be provided. The gas diffusion layer may have a porous structure to smoothly diffuse oxygen. For example, the gas diffusion layer may include a carbon fiber-based material such as carbon paper, carbon cloth, or carbon felt, or may include a sponge-like porous metal or a metal fiber mat. The cathode 20 may have a porous structure or a similar structure to also function as a gas diffusion layer, and the gas diffusion layer may be omitted.

Although not shown in FIGS. 1 and 2, a cathode current collector may be provided in contact with the cathode 20. The cathode current collector may include a conductor such as stainless steel. The cathode current collector may be in contact with the gas diffusion layer, and the cathode current collector may have a mesh structure capable of passing air therethrough.

For example, in a case in which aluminum (Al) is employed as a material of the metal anode 10, the following reactions may occur in the metal-air battery cell 1 during discharge.
Cathode reaction: 3O₂+6H₂O+12e⁻→12OH⁻ E₀=+0.4 V
Anode reaction: 4Al+12OH⁻→4Al(OH)₃+12e⁻ E₀=−2.31 V
Overall reaction: 4Al+3O₂+6H₂O→4Al(OH)₃ E₀=+2.71 V

Water (H₂O), oxygen (O₂) supplied from air, and electrons (e⁻) may combine on a surface of the cathode 20 to generate hydroxide ions (OH⁻). Aluminum (Al) of the metal anode 10 reacts with the hydroxide ions (OH⁻) to produce aluminum hydroxide (Al(OH)₃) as a reaction product and generate electrons (e⁻). The electrons (e⁻) may be supplied to the cathode 20 through a wire that is not shown.

Furthermore, the following corrosion reaction may occur around the metal anode 10 in addition to the anode reaction described herein.
Corrosion reaction: 2Al+6OH⁻+6H₂O→2Al(OH)₃+3H₂

The aluminum hydroxide (Al(OH)₃) generated as a reaction product in the anode reaction and the corrosion reaction may adhere to a surface of the metal anode 10 or accumulate in a lower end portion of the electrolyte 30. The reaction product may adhere to the surface of the metal anode 10, and uniform or continuous reactions in the metal-air battery cell 1 may be limited.

The metal-air battery cell 1 of an embodiment may have a relatively simple structure capable of preventing the reaction product from adhering to the surface of the metal anode 10 or removing the reaction product adhered to the metal anode 10. The metal-air battery cell 1 may be configured to rotate the metal anode 10 relative to the electrolyte 30.

For example, the metal-air battery cell 1 may include an anode rotator 40 that is configured to rotate the metal anode 10 relative to the cathode 20 and in the electrolyte 30 filled in the cathode 20, e.g., the cathode 20 may have a structure into which the electrolyte 30 is provided.

The anode rotator 40 may rotate the metal anode 10 on a rotation axis parallel to the length direction of the metal anode 10. For example, the anode rotator 40 may rotate the metal anode 10 such that the reaction product may not adhere to the surface of the metal anode 10. For example, the rotational speed of the metal anode 10 rotated by the anode rotator 40 may be greater than or equal to a predetermined value. For example, the rotational speed of the metal anode 10 may be greater than or equal to 50 rpm (revolutions per minute). For example, the rotational speed of the metal anode 10 may be in a range of about 100 rpm to about 1,000 rpm.

The anode rotator 40 may be disposed above the electrolyte 30. The anode rotator 40 may be configured to rotate the metal anode 10 while supporting the metal anode 10. Although not shown in FIGS. 1 and 2, a plurality of bearings may be disposed between the anode rotator 40 and the cathode 20. Owing or due to, for example, the bearings, the anode rotator 40 and the metal anode 10 supported by the anode rotator 40 may be rotated relative to the cathode 20. Various structures capable of rotating the metal anode 10 relative to the cathode 20 may be employed.

The cathode 20 may surround a lateral surface of the metal anode 10 at a distance from the metal anode 10, e.g., the cathode 20 may be spaced apart from the metal anode 10. For example, the metal anode 10 may have a columnar shape, and the cathode 20 may have a cylindrical shape surrounding the metal anode 10 at a distance from the metal anode 10, e.g., the cylindrical cathode 20 may be spaced apart from the columnar metal anode 10.

The electrolyte 30 may be filled inside the cathode 20, e.g., the cathode 20 may have a structure into which the electrolyte 30 is provided, and may surround and come into contact with the metal anode 10, e.g., the electrolyte 30 may contact the metal anode 10. The electrolyte 30 may be provided between the metal anode 10 and the cathode 20 such that the electrolyte 30 may be in contact with a lengthwise end portion, also referred to herein as the lower end portion or the end, of the metal anode 10 and a lateral surface of the metal anode 10. The lateral surface and a lower end portion of the metal anode 10 may be exposed to, e.g., contact, the electrolyte 30. A portion of the lateral surface and the lower end portion of the metal anode 10 may be exposed to, e.g., contact, the electrolyte 30.

In the metal-air battery cell 1 including the cathode 20, the electrolyte 30, and the metal anode 10, the metal anode 10 may be rotated by the anode rotator 40. As the metal anode 10 rotates relative to the cathode 20 and in the electrolyte 30, circulation or convection effects may occur in the electrolyte 30, and the reaction product adhering to the periphery of the metal anode 10 may be separated or removed from the metal anode 10.

In the metal-air battery cell 1 of an embodiment, the reaction product adhering to the periphery of the metal anode 10 may be separated owing or due to, for example, the addition of a relatively simple structure, that is, the addition of the anode rotator 40 configured to rotate the metal anode 10. The metal-air battery cell 1 of an embodiment may separate the reaction product adhering to the periphery of the metal anode 10 with only a simple structure configured to rotate the metal anode 10, without using an additional component such as a vibrator or a plasma device configured to remove the reaction product adhering to the metal anode 10, or a circulation device configured to circulate the electrolyte 30.

In the metal-air battery cell 1 of an embodiment, current may be concentrated at an end of the metal anode 10 when the metal anode 10 is rotated by the anode rotator 40.

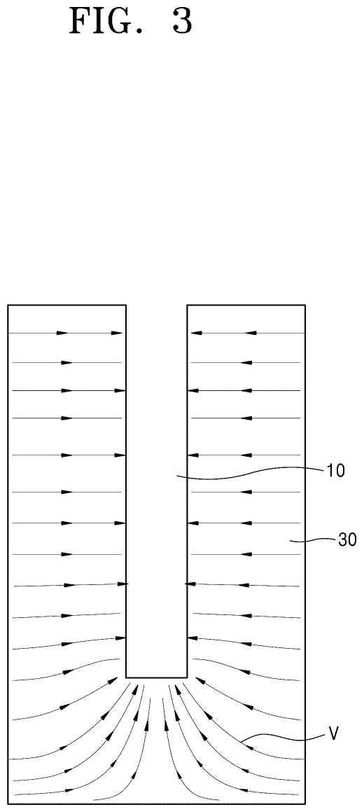

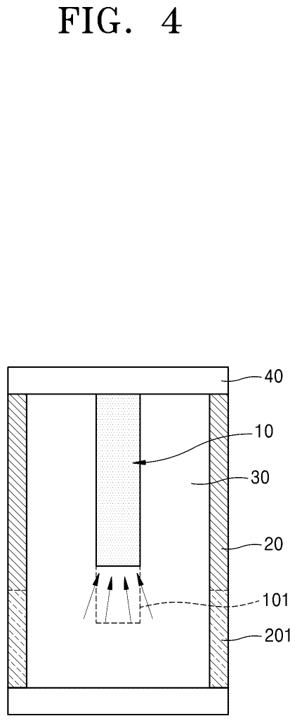

FIG. 3 is a view illustrating current density vectors V in the electrolyte 30 around the metal anode 10 when the metal-air battery cell 1 is discharging in a state in which, e.g., while, the metal anode 10 is rotating according to an embodiment. FIG. 4 is a view illustrating a state of the metal anode 10 when discharge of the metal-air battery cell 1 is in progress, e.g., while the metal-air battery cell is discharging.

FIG. 3 shows that the current density in the electrolyte 30 surrounding the rotating metal anode 10 is greater in a region adjacent to the lower end portion of the metal anode 10 than in regions adjacent to other portions of the metal anode 10. Current concentrates at the lower end portion of the metal anode 10.

Referring to FIGS. 3 and 4, current may concentrate at the lower end portion of the metal anode 10, and the lower end portion of the metal anode 10 may be consumed first. When the lower end portion of the metal anode 10 is consumed, the length of the metal anode 10 may become shorter as the discharge of the metal-air battery cell 1 proceeds.

When the length of the metal anode 10 becomes shorter, a discharge reaction may not occur at a portion 201 of the cathode 20 that is located around a consumed portion 101 of the metal anode 10, and the output power of the metal-air battery cell 1 may be reduced. Operation of the metal-air battery cell 1 may be interrupted, and the metal anode 10 may be replaced to prevent a decrease in the output power of the metal-air battery cell 1.

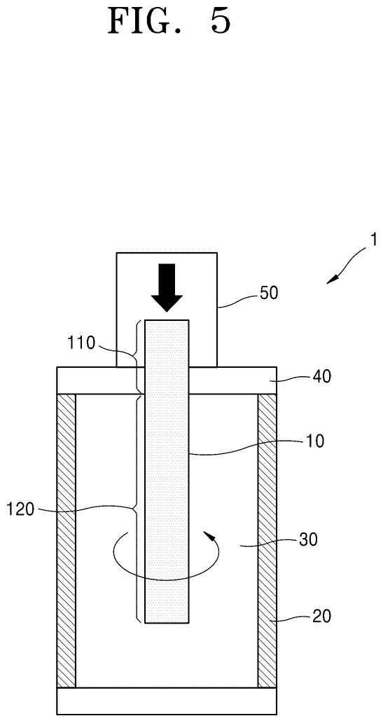

FIG. 5 is a view schematically illustrating the metal-air battery cell 1 according to an embodiment.

Referring to FIG. 5, the metal-air battery cell 1 of an embodiment may be configured to increase an area of the lateral surface of the metal anode 10 in the electrolyte 30 taking into consideration the possibility that the lower end portion of the metal anode 10 may be consumed and shortened. For example, the metal-air battery cell 1 may further include an anode injector 50 that is configured to move the metal anode 10 in the length direction of the metal anode 10 (see arrow in anode injector 50) to inject the metal anode 10 into the electrolyte 30.

As used herein, the term “inject” refers to movement of the metal anode to increase an area of the lateral surface of the metal anode contacting the electrolyte. The phrase “injecting the metal anode into the electrolyte” does not preclude the metal anode from being partially injected into the electrolyte prior to operation of the anode injector.

The metal anode 10 may include a reaction region 120 that is surrounded by the cathode 20 and is in contact with the electrolyte 30. The metal anode 10 may include, in addition to the reaction region 120, a reserve region 110 that extends from the reaction region 120 and is not injected into the electrolyte 30, e.g., a lateral surface of the reserve region is not in contact with the electrolyte. The length of the metal anode 10 may be greater than the length of the reaction region 120.

The anode injector 50 may inject, e.g., move, the metal anode 10 such that the reaction region 120 in contact with the electrolyte 30 may be maintained within a predetermined range. The anode injector 50 may be configured to inject, into the electrolyte 30, a portion of the metal anode 10 that is not injected into the electrolyte 30.

As the metal anode 10 is injected into the electrolyte 30 by the anode injector 50, the area of the reaction region 120 of the metal anode 10 may be maintained at a constant value. For example, the area of the reaction region 120 of the metal anode 10 surrounded by the cathode 20 may be maintained within a predetermined range. For example, the length of the reaction region 120 may maintain a constant ratio relative to the length of the cathode 20, e.g., the metal anode 10 may be moved further into the electrolyte 30 such that a ratio of the length of the reaction region relative to the length of the cathode 20 is kept constant. For example, the length of the reaction region 120 of the metal anode 10 may maintain at least one-half of the length of the cathode 20, e.g., the metal anode 10 may be moved further into the electrolyte 30 such that the length of the reaction region 120 is at least one-half of the length of the cathode 20. The length of the reaction region 120 of the metal anode 10 may maintain at least two-thirds of the length of the cathode 20, e.g., the metal anode 10 may be moved further into the electrolyte 30 such that the length of the reaction region 120 is at least two-thirds of the length of the cathode 20. The length of the reaction region 120 of the metal anode 10 may maintain at least four-fifths of the length of the cathode 20, e.g., the metal anode 10 may be moved further into the electrolyte 30 such that the length of the reaction region 120 is at least four-fifths of the length of the cathode 20. The length of the reaction region 120 of the metal anode 10 may be less than the length of the cathode 20.

Before the anode injector 50 operates in the metal-air battery cell 1, the metal anode 10 may be partially injected into the electrolyte 30. For example, during a manufacturing process of the metal-air battery cell 1, or prior to the start of a discharge reaction of the metal-air battery cell 1, the metal-air battery cell 1 may be in a state in which the metal anode 10 is partially injected into the electrolyte 30. For example, the metal anode 10 may be positioned such that an upper portion of the metal anode 10 is not in contact with the electrolyte 30, and a lower portion of the metal anode 10 is in contact with the electrolyte 30.

As the anode injector 50 operates, the reserve region 110 of the metal anode 10 may be injected into the electrolyte 30 by the anode injector 50. The lower end portion of the metal anode 10 exposed to, e.g., contact, the electrolyte 30 may be consumed during discharge of the metal-air battery cell 1, and the length of the reaction region 120 of the metal anode 10 that is in contact with the electrolyte 30 may be maintained within a certain, e.g., predetermined, range as the reserve region 110 of the metal anode 10 is injected into the electrolyte 30. As the metal anode 10 is injected into the electrolyte 30, the reserve region 110 of the metal anode 10 becomes shorter. The overall length of the metal anode 10 becomes shorter.

The anode injector 50 may be configured to move the metal anode 10 in the length direction of the metal anode 10. For example, the anode injector 50 may be disposed on a lateral surface of the reserve region 110 of the metal anode 10 and configured to move the reserve region 110 in a downward direction, e.g., a direction such at least a portion of the reserve region 110 contacts the electrolyte. For example, although not shown in FIG. 5, the anode injector 50 may include a lead screw that is provided on the lateral surface of the reserve region 110 of the metal anode 10 and configured to move the reserve region 110 of the metal anode 10 in the downward direction. The lead screw may be rotated by a drive motor such as a step motor to move the metal anode 10 in the downward direction.

The configuration of the anode injector 50 is not limited thereto, and various modifications may be made, provided that the anode injector 50 is capable of moving the metal anode 10 into the electrolyte 30. For example, a cylinder, such as a hydraulic cylinder or a pneumatic cylinder, may be used as a component of the anode injector 50 taking into consideration the weight of the metal anode 10 injected by the anode injector 50. For example, a cam structure designed taking into consideration the injection speed of the metal anode 10 may be used as a component of the anode injector 50. For example, a guide rail configured to guide vertical movements of the metal anode 10 may be used as a component of the anode injector 50 taking into consideration the precision of the vertical movements of the metal anode 10. For example, an electric actuator may be used as a component of the anode injector 50 taking into consideration the installation space and control precision of the anode injector 50. For example, a gear reducer may be used as a component of the anode injector 50 taking into consideration the weight of the metal anode 10 and control precision. For example, a spring may be used as a component of the anode injector 50 taking into consideration natural pressure control. For example, a belt drive with relatively low vibration and friction may be used as a component of the anode injector 50 taking into consideration smooth injection of the metal anode 10. For example, the anode injector 50 may be disposed above the reserve region 110 of the metal anode 10 and configured to push down the reserve region 110 of the metal anode 10 in the downward direction.

The anode injector 50 may continuously inject the metal anode 10 into the electrolyte 30. For example, the anode injector 50 may inject the metal anode 10 into the electrolyte 30 at a constant speed. For example, the anode injector 50 may inject the metal anode 10 at a constant speed while the metal anode 10 is rotating. The injection speed of the metal anode 10 into the electrolyte 30 may be determined taking into consideration the amount of the metal anode 10 consumed during discharge.

The anode injector 50 may discontinuously inject the metal anode 10 into the electrolyte 30. For example, the anode injector 50 may intermittently inject the metal anode 10. For example, the anode injector 50 may periodically inject the metal anode 10 into the electrolyte 30. For example, the anode injector 50 may inject the metal anode 10 every time the rotation of the metal anode 10 is stopped.

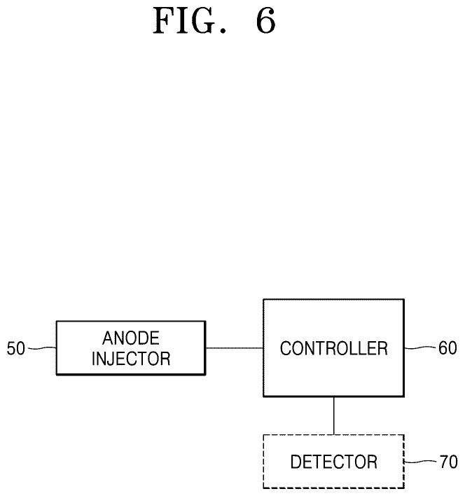

FIG. 6 is a block diagram illustrating an operation of the metal-air battery cell 1 according to an embodiment. Referring to FIG. 6, in the metal-air battery cell 1 of an embodiment, the anode injector 50 may be operated based on information detected by a detector 70.

For example, the detector 70 may detect information about the state of the metal anode 10. For example, the detector 70 may detect the output power of the metal-air battery cell 1.

A controller 60 may control the operation of the anode injector 50 based on the information detected by the detector 70. For example, the controller 60 may control the operation of the anode injector 50 based on detected variations in the output power of the metal-air battery cell 1. For example, when a detected variation in the output power of the metal-air battery cell 1 deviates from a predetermined reference, the controller 60 may determine that the length of the reaction region 120 of the metal anode 10 has decreased. The controller 60 may operate the anode injector 50 to move the metal anode 10 in the length direction of the metal anode 10 and to maintain the length of the reaction region 120 of the metal anode 10.

In an embodiment, the detector 70 detects the output power of the metal-air battery cell 1. For example, the detector 70 may detect the length of the metal anode 10, the weight of the metal anode 10, or the like. In an embodiment, the detector 70 is illustrated as a component of the metal-air battery cell 1. The detector 70 may be omitted.

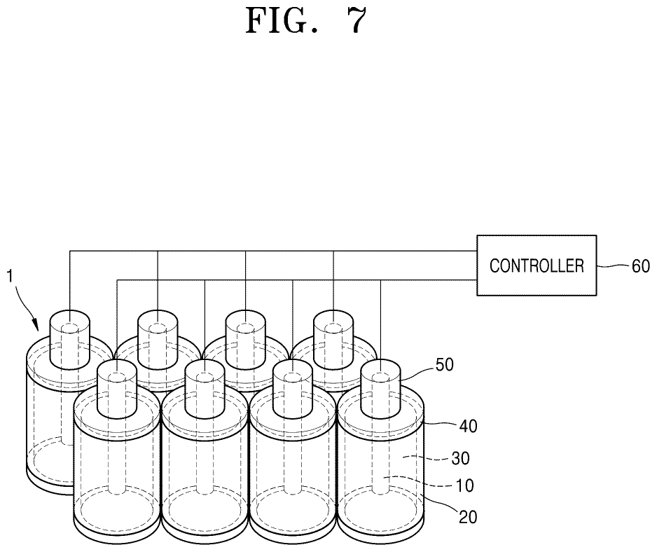

FIG. 7 is a view illustrating a metal-air battery according to an embodiment.

Referring to FIG. 7, the metal-air battery may include a plurality of metal-air battery cells 1. The metal-air battery cells 1 may be arranged in a direction perpendicular to a length direction of metal anodes 10. The metal-air battery cells 1 may be electrically connected in series or in parallel to each other. As described herein, each of the metal-air battery cells 1 may include a metal anode 10, a cathode 20, an electrolyte 30, an anode rotator 40, and an anode injector 50. The metal-air battery may include a controller 60 configured to individually or selectively control the anode injectors 50.

The controller 60 may individually control the anode injectors 50 of the metal-air battery cells 1 based on output power levels of the metal-air battery cells 1 detected by a detector 70 (refer to FIG. 6). The metal anodes 10 of some of the metal-air battery cells 1 may be consumed, and the consumed metal anodes 10 of the metal-air battery cells 1 may be selectively injected. The metal anodes 10 of some metal-air battery cells 1 may be consumed during discharge of the metal-air battery, a reaction area of the metal-air battery may be maintained by selectively operating the anode injectors 50, and the metal-air battery of an embodiment may provide constant output power.

Hereinafter, an operation method of the metal-air battery or the metal-air battery cells 1 included in the metal-air battery will be described.

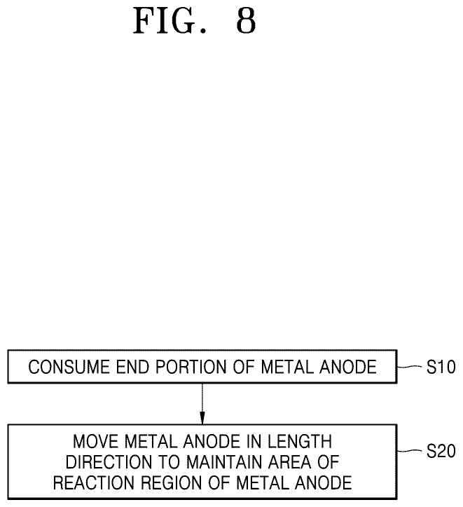

FIG. 8 is a view schematically illustrating an operation method of the metal-air battery according to an embodiment. Referring to FIGS. 5 and 8, the operation method of the metal-air battery according to an embodiment includes an operation S10 in which a lengthwise end portion of the metal anode 10 of at least one metal-air battery cell 1 is consumed. For example, when the at least one metal-air battery cell 1 discharges, the metal anode 10 of the at least one metal-air battery cell 1 may be rotated by the anode rotator 40. As the metal anode 10 is rotated by the anode rotator 40, current may be concentrated at an end portion of the metal anode 10, for example, at a lower end portion of the metal anode 10, and the lower end portion of the metal anode 10 may be consumed first.

In the metal-air battery of an embodiment, an end portion of the metal anode 10 may be consumed as described herein, and the operation method of the metal-air battery may include an operation S20 of moving the metal anode 10 in the length direction of the metal anode 10. For example, the operation S20 of moving the metal anode 10 in the length direction of the metal anode 10 may proceed simultaneously with the operation S10 of consuming the metal anode 10. The operation S20 of moving the metal anode 10 in the length direction of the metal anode 10 may proceed after the operation S10 of consuming the metal anode 10.

As the metal anode 10 is moved in the length direction of the metal anode 10 and injected into the electrolyte 30, an area of the reaction region 120 of the metal anode 10 may be maintained. The area of the reaction region 120 of the metal anode 10 may refer to an area that faces the cathode 20 and is in contact with the electrolyte 30. The area of the reaction region 120 of the metal anode 10 may be maintained within a predetermined range. According to an embodiment, the area of the reaction region 120 of the metal anode 10 of the at least one metal-air battery cell 1 may be maintained, and the output power of the at least one metal-air battery cell 1 or the metal-air battery including the at least one metal-air battery cell 1 may be maintained at a constant level.

The at least one metal-air battery cell 1 of an embodiment includes the anode rotator 40 configured to rotate the metal anode 10, and the anode injector 50 configured to inject the metal anode 10 into the electrolyte 30. The anode rotator 40 may be omitted. For example, the at least one metal-air battery cell 1 may include the anode injector 50 but may not include the anode rotator 40.

According to an embodiment described herein, the metal-air battery cell has a cylindrical structure with a mechanism for maintaining the length of the metal anode in contact with the electrolyte within a predetermined range, e.g., at a constant value, and a decrease in the output power of the metal-air battery may be suppressed or reduced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A metal-air battery cell comprising:
a metal anode comprising an end and a lateral surface extending from the end;
a cathode surrounding and spaced apart from the lateral surface of the metal anode;
an electrolyte between the metal anode and the cathode and in contact with the end of the metal anode and a portion of the lateral surface of the metal anode; and
an anode injector configured to move the metal anode to increase an area of the lateral surface of the metal anode contacting the electrolyte.

2. The metal-air battery cell of claim 1, wherein the metal anode comprises:
a reaction region, wherein a lateral surface of the reaction region is surrounded by the cathode and in contact with the electrolyte; and
a reserve region extending from the reaction region, wherein a lateral surface of the reserve region is not in contact with the electrolyte.

3. The metal-air battery cell of claim 2, wherein the anode injector is configured to move at least a portion of the reserve region into the electrolyte.

4. The metal-air battery cell of claim 3, wherein, as the at least a portion of the reserve region is moved into the electrolyte by the anode injector, a length of the reserve region of the metal anode decreases.

5. The metal-air battery cell of claim 2, wherein the anode injector is configured to continuously move the at least a portion of the reserve region into the electrolyte.

6. The metal-air battery cell of claim 2, wherein the anode injector is configured to discontinuously move the at least a portion of the reserve region into the electrolyte.

7. The metal-air battery cell of claim 6, further comprising:
a detector configured to detect information about a state of the metal anode; and
a controller configured to control operation of the anode injector, based on the information detected by the detector.

8. The metal-air battery cell of claim 1, further comprising an anode rotator configured to rotate the metal anode in the electrolyte.

9. The metal-air battery cell of claim 8, wherein the anode rotator is further configured to continuously rotate the metal anode.

10. The metal-air battery cell of claim 8, wherein the anode rotator is further configured to discontinuously rotate the metal anode.

11. The metal-air battery cell of claim 8, wherein the metal anode has a columnar shape, and
the cathode has a cylindrical shape.

12. A metal-air battery comprising a plurality of metal-air battery cells,
wherein each of the plurality of metal-air battery cells comprises:
a metal anode comprising an end and a lateral surface extending from the end;
a cathode surrounding and spaced apart from the lateral surface of the metal anode;
an electrolyte between the metal anode and the cathode and in contact with the end of the metal anode and a portion of the lateral surface of the metal anode; and
an anode injector configured to move the metal anode to increase an area of the lateral surface of the metal anode contacting the electrolyte.

13. The metal-air battery of claim 12, wherein the metal anode comprises:
a reaction region, wherein a lateral surface of the reaction region is surrounded by the cathode and in contact with the electrolyte; and
a reserve region extending from the reaction region, wherein a lateral surface of the reserve region is not in contact with the electrolyte.

14. The metal-air battery of claim 13, wherein the anode injector is configured to move at least a portion of the reserve region into the electrolyte.

15. The metal-air battery of claim 14, wherein, as the at least a portion of the reserve region is moved into the electrolyte by the anode injector, a length of the reserve region of the metal anode decreases.

16. The metal-air battery of claim 12, wherein the anode injector is configured to continuously move the at least a portion of the reserve region into the electrolyte.

17. The metal-air battery of claim 12, further comprising:
a detector configured to detect information about a state of the metal anode of each of the plurality of metal-air battery cells; and
a controller configured to individually control operation of the anode injector of each of the plurality of metal-air battery cells, based on the information detected by the detector.

18. The metal-air battery of claim 12, wherein each of the plurality of metal-air battery cells further comprises an anode rotator configured to rotate the metal anode in the electrolyte.

19. An operation method of a metal-air battery comprising a metal-air battery cell, the metal-air battery cell comprising a metal anode comprising an end and a lateral surface extending from the end, a cathode surrounding and spaced apart from the lateral surface of the metal anode, the cathode comprising a reaction region facing the cathode and in contact with the electrolyte, and an electrolyte between the metal anode and the cathode and in contact with the end of the metal anode and a portion of the lateral surface of the metal anode, the operation method comprising:
consuming the end of the metal anode; and
moving the metal anode to maintain an area of a lateral surface of the reaction region of the metal anode within a predetermined range.
